(19) United States
(12) Patent Application Publication
(10) Pub. No.: US 2020/0260142 A1
(43) Pub. Date: Aug. 13, 2020

(54) INFORMATION PROCESSING APPARATUS, CONTROL METHOD FOR INFORMATION PROCESSING APPARATUS, AND COMPUTER PROGRAM

(71) Applicant: SONY CORPORATION, TOKYO (JP)

(72) Inventors: SHUNICHI KASAHARA, KANAGAWA (JP); JUNICHI REKIMOTO, KANAGAWA (JP); JUN KIMURA, KANAGAWA (JP); TAIZO SHIRAI, KANAGAWA (JP)

(21) Appl. No.: 15/764,399

(22) PCT Filed: Sep. 28, 2016
(86) PCT No.: PCT/JP2016/078736

§ 371 Date: Mar. 29, 2018

(30) Foreign Application Priority Data
Oct. 20, 2015 (JP) 2015-206659

(51) Int. Cl. H04N 21/45; H04N 21/6587; H04N 21/4788; H04N 21/414

(52) U.S. Cl. CPC H04N 21/4532; H04N 21/41407; H04N 21/4788; H04N 21/6587

(57) ABSTRACT

To provide an information processing apparatus that provides content information, a control method for an information processing apparatus, and a computer program. An information processing apparatus sets, in response to a request of access of an information terminal apparatus of a second user to content information associated with a space of a first user, an information amount of the content information to be provided to the second user on a basis of relevant information of at least one of the information terminal apparatus of the second user and the second user, or the content information.

### TECHNICAL FIELD

The technology disclosed in the present specification relates to an information processing apparatus that provides content information, a control method for an information processing apparatus, and a computer program.

### BACKGROUND ART

The technology is known that allows a user to access a sight (scene from a mobile object other than the user) from a person or an object other than the user.

For example, there has been proposed a mobile camera system that remotely acquires an image captured by a mobile camera mounted on a mobile object such as a vehicle (e.g., see Patent Literature 1). In addition, there has been proposed an image processing system that provides a person who wears a head-mounted display with information similar to visual information acquired by a person who wears eyeglasses in which an imaging sensing wireless apparatus is disposed (e.g., see Patent Literature 2). In addition, there has been proposed an image display system in which a display apparatus side that displays a captured image of a mobile object designates, for an imaging apparatus of the mobile body, a viewpoint position and a line-of-sight direction for performing imaging, and speed at the time of imaging (e.g., see Patent Literature 3).

Further, the telepresence technology has also been proposed that transmits, through an interval such as the sight of a robot in a remote location, a sensation that a person feels as if the person were on the spot, and provides an interface for operating an object in the remote location (e.g., see Patent Literature 4).

### CITATION LIST

### Patent Literature

Patent Literature 1: JP 2006-186645A

Patent Literature 2: JP 2004-222254A

Patent Literature 3: JP 2008-154192A

Patent Literature 4: JP 2014-522053T

Patent Literature 5: JP 2014-104185A

### DISCLOSURE OF INVENTION

### Technical Problem

An object of the technology disclosed in the present specification is to provide an information processing apparatus that provides content information, a control method for an information processing apparatus, and a computer program.

### Solution to Problem

The technology disclosed in the present specification is devised in view of the above-described problem, and a first aspect thereof is an information processing apparatus including: a setting unit configured to, in response to a request of access of an information terminal apparatus of a second user to content information associated with a space of a first user, set an information amount of the content information to be provided to the second user on a basis of relevant information of at least one of the information terminal apparatus of the second user and the second user, or the content information.

In addition, a second aspect of the technology disclosed in the present specification is an information processing method including: a step of acquiring a request of access of an information terminal apparatus of a second user to content information associated with a space of a first user; and a setting step of setting, in response to the acquired request of access, an information amount of the content information to be provided to the second user on a basis of relevant information regarding at least one of the information terminal apparatus of the second user and the second user, or the content information.

In addition, a third aspect of the technology disclosed in the present specification is a computer program described in a computer-readable format, the computer program causing a computer to execute: a step of acquiring a request of access of an information terminal apparatus of a second user to content information associated with a space of a first user; and a setting step of setting, in response to the acquired request of access, an information amount of the content information to be provided to the second user on a basis of relevant information regarding at least one of the information terminal apparatus of the second user and the second user, or the content information.

### Advantageous Effects of Invention

According to the technology disclosed in the present specification, it is possible to provide an information processing apparatus that provides content information, a control method for an information processing apparatus, and a computer program.

Note that the advantageous effects described in this specification are merely for the sake of example, and the advantageous effects of the present invention are not limited thereto. Furthermore, in some cases the present invention may also exhibit additional advantageous effects other than the advantageous effects given above.

### BRIEF DESCRIPTION OF DRAWINGS

FIG. 1 is a diagram illustrating an overview of a visual information sharing system 100 to which technology disclosed in the present specification is applied.

FIG. 2 is a diagram schematically illustrating one-to-N network topology.

FIG. 3 is a diagram schematically illustrating N-to-one network topology.

FIG. 4 is a diagram schematically illustrating N-to-N network topology.

FIG. 5 illustrates a functional configuration example of an image providing apparatus 101 and an image display apparatus 102.

FIG. 6 is a diagram schematically illustrating a start flow of Body initiative start.

FIG. 7 is a diagram schematically illustrating a start flow of Ghost initiative start.

FIG. 8 is a flowchart illustrating a schematic processing procedure for matching permission set for a Body with a mission set for a Ghost.

FIG. 9 is a flowchart illustrating a processing procedure for a Body to set a permission level for a Ghost.

FIG. 10 is a diagram illustrating an example of a UI that allows a Ghost to select a Body on a basis of position information of Bodies.

FIG. 11 is a diagram illustrating an example of a UI that allows a Ghost to select a Body on a basis of position information of Bodies.

FIG. 12 is a diagram that exemplifies a tag displayed on a Body selection UI.

FIG. 13 is a diagram illustrating another example of a UI that allows a Body to select a Ghost.

### MODE(S) FOR CARRYING OUT THE INVENTION

Hereinafter, an embodiment of the technology disclosed in the present specification will be described in detail with reference to the drawings.

### A. Overview of System

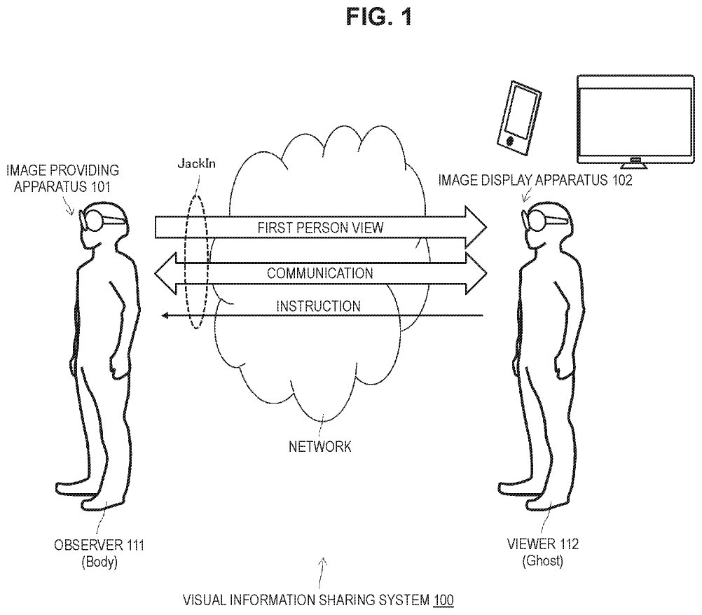

FIG. 1 illustrates the overview of a visual information sharing system 100 to which the technology disclosed in the present specification is applied. The illustrated visual information sharing system 100 includes the combination of an image providing apparatus 101 that provides an image obtained by capturing an image of a site, and an image display apparatus 102 that displays the image provided from the image providing apparatus 101. The image providing apparatus 101 may be regarded as an information processing apparatus or an information terminal apparatus.

The image providing apparatus 101 specifically includes a camera-equipped see-through head-mounted display mounted on the head of an observer 111 who does actually activities on a site. The “see-through” head-mounted display here may be basically an optically transmissive head-mounted display, but may also be a video see-through head-mounted display. The camera mounted on the head-mounted display provides video obtained by performing imaging substantially in the line-of-sight direction of the observer 111. That is, the image providing apparatus 101 may be regarded as a portable information processing apparatus for a user. Note that the image providing apparatus is not limited to an apparatus worn on the head. As long as the image providing apparatus is an apparatus capable of acquiring imaging information regarding the area around the observer 111, the configuration of the apparatus is not limited in particular.

Meanwhile, it is assumed that the image display apparatus 102 is disposed apart from the site, that is, the image providing apparatus 101, and the image providing apparatus 101 and the image display apparatus 102 communicate with each other via a network. The term “apart” here includes not only a remote location, but also a situation in which the image providing apparatus 101 and the image display apparatus 102 are slightly (e.g., approximately several meters) apart from each other in the same room. In addition, it is also assumed that data is exchanged between the image providing apparatus 101 and the image display apparatus 102 via a server apparatus (not illustrated).

The image display apparatus 102 is, for example, a head-mounted display worn by a person who is not on the site (viewer of captured image) 112. By using an immersive head-mounted display for the image display apparatus 102, the viewer 112 is able to experience the same scene as that of the observer 111 more realistically. However, a see-through head-mounted display may also be used for the image display apparatus 102.

In addition, the image display apparatus 102 is not limited to a head-mounted display, but may be, for example, a wrist-watch display. Alternatively, the image display apparatus 102 does not have to be a wearable terminal, but may be a multifunctional information terminal such as a smartphone or a tablet, a general monitor display of a computer screen, a television receiver or the like, a game console, a projector that projects an image on a screen, or the like. In the present disclosure, the types of these terminals or apparatuses may be regarded as relevant information or attribute information of external information processing apparatuses (information terminal apparatuses). In addition, the performance or output format of the external information processing apparatuses can also be included in the relevant information of the information processing apparatuses. For example, the performance of an external information processing apparatus can include a parameter such as the resolution, the frame rate, the transmission rate, or the decoding rate. The output format of an external information processing apparatus may include a sound output, an image output, a tactile output, and the like.

The observer 111 is actually on the site and does activities with his or her body. Accordingly, the observer 111 (or the image providing apparatus 101) who is a user of the image providing apparatus 101 (information processing apparatus) will also be referred to as “Body” below. In contrast, the viewer 112 does not act on a spot with his or her body, but is able to be conscious of the spot by viewing video taken from the viewpoint of the observer 111. Thus, the viewer 112 (or the image display apparatus 102) who is a user of the image display apparatus 102 will also be referred to as “Ghost.”

A Body transmits his or her surrounding situation to a Ghost, and further shares the situation with the Ghost. One of the Ghosts is able to communicate with the Body, and achieve interactions such as operation support from a location that is spaced apart. It will also be referred to as “JackIn” below for a Ghost to interact with video sent from a Body in the visual information sharing system 100.

The visual information sharing system 100 has basic functions of transmitting video from a Body to a Ghost to allow the Ghost side to view and experience the video, and establishing communication between the Body and the Ghost. By using the latter communication function, a Ghost is able to interact with a Body according to intervention from a remote location, such as “visual intervention” that allows the Ghost to intervene in the vision of the Body, “auditory intervention” that allows the Ghost to intervene in the hearing of the Body, “body intervention” that allows the Ghost to move or stimulate the body of the Body or a part of the body, and “alternative conversation” that allows the Ghost to talk on a site instead of the Body. It is also possible to say that JackIn offers a plurality of communication channels such as “visual intervention,” “auditory intervention,” “body intervention,” and “alternative conversation.” The details of “visual intervention,” “auditory intervention,” “body intervention,” and “alternative conversation” will be described below.

The Ghost is able to instruct the Body about behavior on a site through “visual intervention,” “auditory intervention,” “body intervention,” or “alternative conversation.” For example, the visual information sharing system 100 is usable for operation support in various industrial fields such as a medical field including surgery and the like, and a construction site of a construction work and the like, instructions about control of an airplane and a helicopter and guidance thereof, navigation of a driver of an automobile, coaching, instructions in sports, or the like.

For example, in addition to the case where a Body wants to share his or her vision with another person, in the case where the Body wants (or has) to be assisted, instructed, guided, and navigated by another person regarding operation that the Body is currently performing according to the visual intervention or the like, the Body takes the initiative in performing JackIn with an appropriate Ghost (Body initiative start).

Further, in addition to the case where a Ghost wants to view video of a site without visiting the site, in the case where the Ghost wants (or has) to assist, instruct, guide, and navigate another person regarding operation that the other person is currently performing, the Ghost takes the initiative in performing JackIn with the corresponding Body (Ghost initiative start).

However, when the Body is subjected to visual intervention, auditory intervention, body intervention, or conversational intervention with no restriction, the behavior of the Body is interrupted by the Ghost, or the behavior of the Body is hindered and put in danger in some cases, and the privacy is sometimes invaded. Meanwhile, the Ghost also has some video that the Ghost does not want to watch in some cases, or the Ghost is not able to provide services such as appropriate assistance, instruction, guidance, and navigation to the Body in some cases even if asked. Thus, JackIn of the Ghost to the Body and intervention in the Body from the Ghost in a JackIn state may be restricted at a certain level.

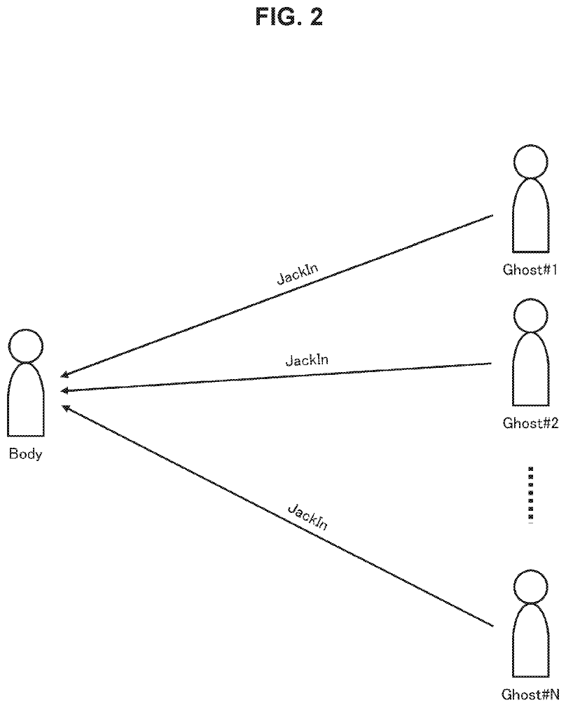

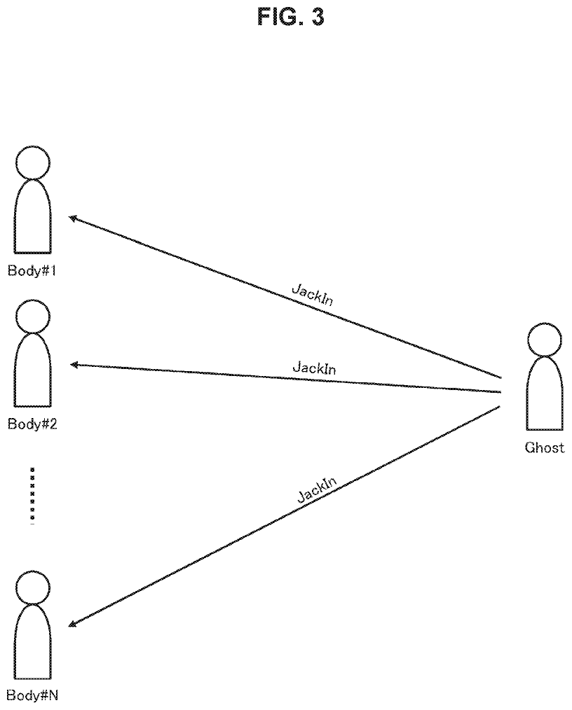

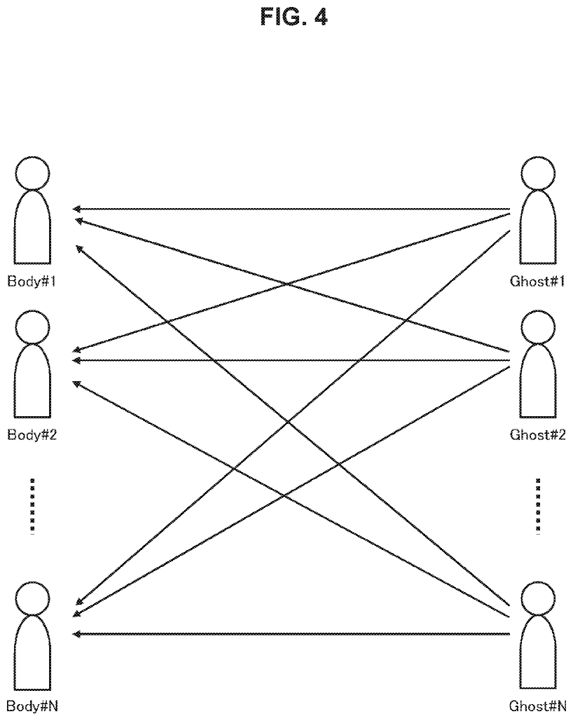

Note that, for the sake of simplification, FIG. 1 illustrates one-to-one network topology of a Body and a Ghost in which only the one image providing apparatus 101 and the one image display apparatus 102 exist. The following are also assumed: one-to-N network topology as illustrated in FIG. 2 in which one Body and a plurality (N) of Ghosts simultaneously perform JackIn, N-to-one network topology as illustrated in FIG. 3 in which a plurality (N) of Bodies and one Ghost simultaneously perform JackIn, and N-to-N network topology as illustrated in FIG. 4 in which a plurality (N) of Bodies and a plurality (N) of Ghosts simultaneously perform JackIn are also assumed.

In addition, switching one apparatus from a Body to a Ghost, switching one apparatus from a Ghost to a Body in contrast, and simultaneously providing one apparatus with the role of a Body and the role of a Ghost are also assumed. Network topology (not illustrated) is also assumed in which one apparatus performs JackIn to a certain Body as a Ghost, and simultaneously functions as a Body for another Ghost to establish a daisy-chain connection between three or more apparatuses. In any network topology, a server apparatus (not illustrated) is sometimes interposed between a Body and a Ghost.

### B. Functional Configuration

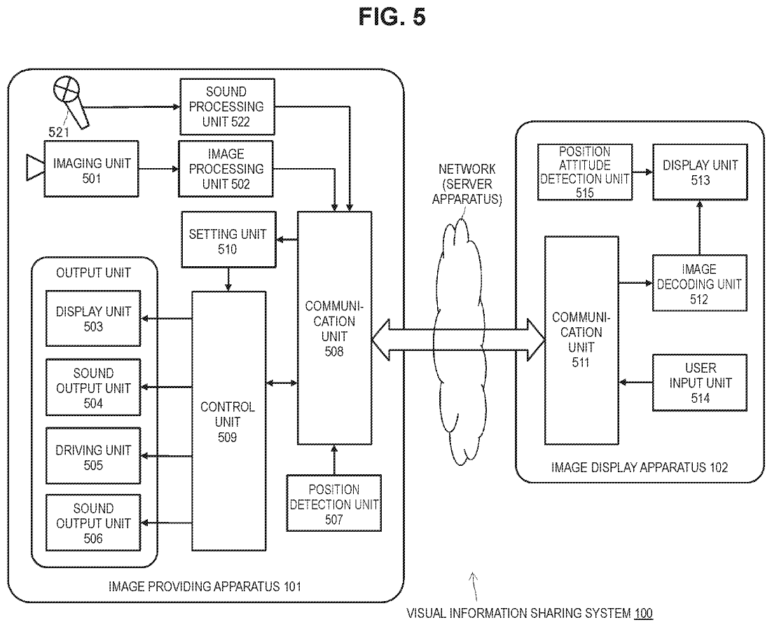

FIG. 5 illustrates a functional configuration example of the image providing apparatus 101 and the image display apparatus 102.

The image providing apparatus 101 is an apparatus to be used by a user (observer 112) who acts the role of a Body. In the example illustrated in FIG. 5, the image providing apparatus 101 includes an imaging unit 501, an image processing unit 502, a display unit 503 serving as an output unit, a first sound output unit 504, a drive unit 505 and a second sound output unit 506, a position detection unit 507, a communication unit 508, a control unit 509, and a setting unit 510. Each of these components 501 to 510 of the image providing apparatus 101 is directly or indirectly provided to the predetermined housing as illustrated in FIG. 1.

The imaging unit 501 includes a camera, and is attached to the head of a Body, that is, the observer 111, for example, to image the area in the line-of-sight direction of the observer 111. Alternatively, a full-dome camera may be used for the imaging unit 501 to provide a 360-degree full-dome image showing the area around the Body. However, the full-dome image does not necessarily have to be a 360-degree image, but the field of view may be partially missing. In addition, the full-dome image may be a half-dome image that does not include a floor surface containing little information (the same applies to the following). Note that the imaging unit 501 only has to acquire captured image information, for example, in the real space, in which the Body, that is, the observer 111 exists, and a variety of apparatus configurations can be employed. As described below, the space in which the Body, that is, the observer 111 exists can also be defined as a virtual space instead of the real space. As described above, the imaging unit 501 only has to acquire information of the space in which the observer 111 exists, but does not have to be directly provided to the image providing apparatus 101. For example, captured image information may be acquired from an imaging apparatus provided in the space in which the observer 111 exists.

The image processing unit 502 processes an image signal output from the imaging unit 501. In the case where video captured by the imaging unit 501 is directly streamed, a Body looks around or changes the line-of-sight direction at his or her own will. Accordingly, the Ghost has to view video that shakes strongly, and there is a concern that the Ghost will be sick. In addition, the Ghost sometimes wants to view another part on which the Body does not focus. The image processing unit 502 then simulatively constructs a surrounding space on the basis of continuous images captured by the imaging unit 501. The “real space” will be simply referred to as “space” below in some cases. Specifically, the image processing unit 502 performs space recognition, in real time, on video (full-dome image) captured by the imaging unit 501, and spatially joins a current video frame and a past video frame together, thereby rendering video from the viewpoint of a virtual camera controlled by the Ghost. The space recognition is based on the simultaneous localization and mapping (SLAM) recognition technology or the like. The video rendered at the viewpoint of the virtual camera is video watched from a viewpoint that is simulatively out of the body of the Body rather than video watched from the viewpoint of the Body. Thus, the Ghost side is able to observe the environment around the Body independently from the motion of the Body, so that it is possible to stabilize the shaking of the video to prevent sickness and view another part on which the Body does not focus.

The sound input unit 521 includes a microphone or the like, and picks up sound generated around the observer 111. The sound processing unit 522 performs signal processing on sound signals from the sound input unit 521, and performs audio coding processing such as advanced audio coding (AAV) as needed.

The display unit 503 displays and outputs information sent from the image display apparatus 102, thereby allowing the Ghost to intervene in the vision of the Body. In the case where the image providing apparatus 101 is configured as a see-through head-mounted display as described above, the display unit 503 superimposes and displays an augmented reality (AR) image that expresses the consciousness of the Ghost who shares experience with the Body on the vision (i.e., scenery of the real world) of the observer 111. The AR image includes an image such as a pointer, an annotation, or the like showing, for example, a location indicated by the Ghost. Thus, the Ghost is able to intervene in the vision of the Body through communication with the Body, and interact with the Body on the site.

The first sound output unit 504 includes, for example, earphones, headphones, or the like, and causes a Body to listen to information sent from the image display apparatus 102, thereby allowing a Ghost to intervene in the hearing of the Body. The image display apparatus 102 transmits information regarding the consciousness of the Ghost who shares experience with the Body. The image providing apparatus 101 side converts the received information into sound signals, and outputs sound from the first sound output unit 504, thereby causing the Body, that is, the observer 111 to listen to the sound. Alternatively, sound signals uttered by the Ghost who is currently viewing the video sent from the Body are transmitted from the image display apparatus 102 as they are. The image providing apparatus 101 side outputs the received sound signals in the form of sound from the first sound output unit 504 as they are, thereby causing the Body, that is, the observer 111 to listen to the sound. In addition, the sound volume, sound quality, output timing, and the like of sound output from the first sound output unit 504 may be adjusted as appropriate. Alternatively, image information or character information (text information) coming from the image display apparatus 102 may be converted into sound signals, and output from the first sound output unit 504 in the form of sound. Thus, the Ghost is able to intervene in the hearing of the Body through communication with the Body, and interact with the Body on the site.

The drive unit 505 moves or stimulates the body of a Body or a part of the body to allow a Ghost to intervene in the body of the Body. The drive unit 505 includes, for example, an actuator for applying tactile stimulation or electrical stimulation (which is slight electrical stimulation, and thus does not harm health) to the body of the observer 111. Alternatively, the drive unit 505 includes an apparatus (e.g., see Patent Literature 5) for supporting or restricting the motion of the body by driving a powered suit or exoskeleton worn on arms, hands, legs, or the like of the observer 111. Thus, the Ghost is able to intervene in the body of the Body through communication with the Body, and interact with the Body on the site.

The second sound output unit 506 includes, for example, a wearable speaker or the like worn by a Body, and outputs information or sound signals coming from the image display apparatus 102 to the outside in the form of sound. The sound output from the second sound output unit 506 sounds on a site as if the Body himself/herself talked. Thus, a Ghost is able to converse with people on the site where the Body is, or issue an instruction with sound instead of the Body (alternative conversation).

The position detection unit 507 detects current position information of the image providing apparatus 101 (i.e., Body) by using, for example, global positioning system (GPS) signals. The detected position information is used, for example, for a Ghost to search for a Body who is in a place desired by the Ghost.

The communication unit 508 is mutually connected to the image display apparatus 102 via a network, transmits video captured by the imaging unit 501 and space information, and communicates with the image display apparatus 102. The communication means of the communication unit 508 may be wireless or wired communication means, and is not limited to a specific communication standard. In addition, the case is also assumed where the communication unit 508 performs information communication with the image display apparatus 102 via a server apparatus (not illustrated).

The setting unit 510 performs authentication processing on the image display apparatus 102 (or a Ghost who is a user thereof), which is connected to the setting unit 510 via a network, or checks attribute information (relevant information) of the Ghost to set the range of information to be provided to the image display apparatus 102, or set the range of information to be output from the output unit among information received from the image display apparatus 102. Here, various kinds of information to be provided from a Body to a Ghost may be regarded as content information associated with the Body. In addition, in the present disclosure, the range of information to be provided to a Ghost may be defined as an information amount provided to the Ghost. For example, the setting unit 510 sets one or both of video input from the imaging unit 501 and sound information input from the sound input unit 521 as the range of information to be provided to the image display apparatus 102 on the basis of attribute information of a Ghost. This can restrict the information amount to be provided from a Body to a Ghost on the basis of the attribute information (relevant information) of the Ghost. For example, at least one of sound information, video information, tactile information, and the like to be provided from a Bosy to a Ghost can be restricted or suppressed. In addition, the setting unit 510 sets the range of information to be output by the output unit among information signals such as sound information, text information, and image information to be received from the image display apparatus 102, on the basis of attribute information of a Ghost. This can cause it to be set whether to make an output for “visual intervention,” “auditory intervention,” “body intervention,” or “alternative conversation” from a Ghost to a Body, that is, the range of information to be output by the various output units can be set.

The control unit 509 has, for example, the functions corresponding to a central processing unit (CPU) and a graphic processing unit (GPU). The control unit 509 controls the output operation from the output unit on the basis of the range of information which is set in accordance with an authentication result of the setting unit 510.

For example, in the case where image information is set as the range of information (in other words, the image display apparatus 102 is permitted to perform only visual intervention as a result of authentication processing), the control unit 509 executes only a display output from the display unit 503. In addition, in the case where sound information is also set as the range of information (in other words, the image display apparatus 102 is permitted to perform not only visual intervention, but also auditory intervention), the control unit 509 executes both a display output from the display unit 503 and a sound output from the first sound output unit 504.

The range of information to be provided from the image providing apparatus 101 to the image display apparatus 102 or the range of information to be received from the image display apparatus 102 (in other words, the range of intervention that a Body permits a Ghost) is defined as a permission level. Meanwhile, the range within which a Ghost intervenes in a Body is defined as a mission level (described below). This intervention from the Ghost to the Body, that is, various signals issued for access may be regarded as a request of access from the Ghost to the Body. For example, in FIG. 5, a component of a server apparatus which receives a request of access issued from the image display apparatus 102 may be regarded as an access reception unit. Alternatively, at least one of the communication unit 508, the setting unit 510, and the control unit 509 of the image providing apparatus 101 may be regarded as an access reception unit. However, it is also possible to configure the visual information sharing system 100 such that the above-described processing performed by the setting unit 510 and the control unit 509 is executed by not the image providing apparatus 101, but a server (not illustrated) interposed between the image providing apparatus 101 and the image display apparatus 102. In this case, the server apparatus may be regarded as an information processing apparatus in the present disclosure. Note that, in FIG. 5, the image providing apparatus 101 receives a request of access from a Ghost indirectly via the server apparatus, that is, directly from the server apparatus. The technology of the present disclosure is not limited thereto. The image providing apparatus 101 may directly receive a request of access from an image display apparatus.

Meanwhile, the image display apparatus 102 is an apparatus to be used by a user (viewer 112) who acts the role of a Ghost. In the example illustrated in FIG. 5, the image display apparatus 102 includes a communication unit 511, an image decoding unit 512, a display unit 513, a user input unit 514, and a position attitude detection unit 515.

The communication unit 511 is mutually connected to the image providing apparatus 101 via a network, receives video from the image providing apparatus 101, and communicates with the image providing apparatus 101. The communication means of the communication unit 511 may be wireless or wired communication means, and is not limited to a specific communication standard. However, it is assumed that the communication means is compatible with the communication unit 508 of the image providing apparatus 101 side. In addition, the case is also assumed where the communication unit 511 performs information communication with the image providing apparatus 101 via a server apparatus (not illustrated).

The image decoding unit 512 performs decoding processing on an image signal received by the communication unit 511 from the image providing apparatus 101. The display unit 513 displays and outputs a full-dome image that has been decoded by the image decoding unit 512. Note that the processing (described above) of rendering viewpoint video out of the body of a Body from viewpoint video of the Body may be performed by not the image processing unit 502 of the image providing apparatus 101 side, but the image decoding unit 512.

The position attitude detection unit 515 detects the position and attitude of the head of the viewer 112. The detected position and attitude correspond to the current viewpoint position and line-of-sight direction of a Ghost. It is possible to control the viewpoint position and line-of-sight direction of the virtual camera (described above) to create viewpoint video simulatively out of the body of a Body from the viewpoint video of the Body on the basis of the position and attitude of the head of the viewer 112 detected by the position attitude detection unit 515.

Note that the position attitude detection unit 515 includes a combination of a plurality of sensor elements, for example, a gyro sensor, an acceleration sensor, a geomagnetic sensor, and the like. As an example, a triaxial gyro sensor, a triaxial acceleration sensor, and a triaxial geomagnetic sensor may be combined into a sensor capable of detecting nine axes in total and applied to the position attitude detection unit 515.

The display unit 513 includes, for example, a head-mounted display worn by the viewer 112 serving as a Ghost. By using an immersive head-mounted display for the display unit 513, the viewer 112 can experience the same scene as that of the observer 111 more realistically. Video viewed by the viewer 112, that is, the Ghost is not the Body's viewpoint video itself, but is a surrounding space simulatively constructed from continuous images thereof (viewpoint video simulatively out of the body of the Body) (described above). In addition, it is possible to perform control the virtual camera to perform head tracking on the Ghost, that is, follow the viewpoint position and line-of-sight direction of the viewer 112 detected by the position attitude detection unit 515, and move the angle of display view of the display unit 513.

A wearable terminal such as a see-through head-mounted display or a wrist-watch display may be used as the display unit 513 instead of an immersive head-mounted display. Alternatively, the display unit 513 does not have to be a wearable terminal, but may be a multifunctional information terminal such as a smartphone or a tablet, a general monitor display such as a computer screen or a television receiver, a game console, a projector that projects an image on a screen, or the like.

The user input unit 514 is a device for allowing the viewer 112 serving as a Ghost to input the Ghost's own intention or consciousness in response to the observation of video that is sent from a Body and displayed on the display unit 513.

The user input unit 514 includes, for example, a coordinate input apparatus such as a touch panel, a mouse, or a joystick. By touching, click operation on the mouse, or the like, a Ghost is able to directly indicate a place in which the Ghost is particularly interested on a screen on which video sent from a Body is displayed. The Ghost gives an indication on pixel coordinates of video that the Ghost is currently viewing. However, the captured video of the Body side always changes, and the indication on the pixel coordinates is meaningless. The user input unit 514 then identifies, by performing image analysis or the like, position information in the three-dimensional space corresponding to a pixel position that the Ghost indicates by touching, performing click operation, or the like on the screen, and transmits the position information in the three-dimensional space to the image providing apparatus 101. Thus, the Ghost is able to perform pointing that achieves fixation not on the pixel coordinates, but in a space.

In addition, the user input unit 514 may capture eye movement by using a captured image of the face of a Ghost taken by a camera or an eye potential, calculate a place at which the Ghost is gazing, and transmit information for identifying the place to the image providing apparatus 101. At that time, the user input unit 514 also identifies, by performing image analysis or the like, position information in the three-dimensional space corresponding to a pixel position at which the Ghost is gazing, and transmits the position information in the three-dimensional space to the image providing apparatus 101. Thus, the Ghost is able to perform pointing that achieves fixation not on the pixel coordinates, but in a space.

In addition, the user input unit 514 includes a character input apparatus such as a keyboard. When a Ghost views sent video to have the same experience as that of a Body, the Ghost is able to input an intention that the Ghost wants to let the Body know, consciousness that the Ghost has, and the like as character information. The user input unit 514 may transmit the character information input by the Ghost as it is to the image providing apparatus 101 or may convert the character information in another signal format such as sound signals and then transmit the signals to the image providing apparatus 101.

In addition, the user input unit 514 includes a sound input apparatus such as a microphone, and sound uttered by the Ghost is input thereto. A user input unit 414 may transmit the input sound from the communication unit 511 to the image providing apparatus 101 in the form of sound signals. Alternatively, the user input unit 514 may also perform sound recognition on the input sound to convert the input sound into character information, and transmit the input sound to the image providing apparatus 101 as character information. This conversion from sound information to character information can suppress the transmission of attribute information, that is, personal information of a Ghost to a Body via sound generated by the Ghost.

It is assumed that a Ghost indicates an object by using a demonstrative pronoun such as “that” or “this” while viewing video sent from a Body. In such a case, the user input unit 514 identifies, by performing language analysis, image analysis, or the like, position information of the object indicated by the demonstrative pronoun in the three-dimensional space, and transmits the position information in the three-dimensional space to the image providing apparatus 101. Thus, the Ghost is able to perform pointing that achieves fixation not on the pixel coordinates, but in a space.

In addition, the user input unit 514 may be a gesture input apparatus into which a body gesture and a hand gesture of a Ghost are input. Means for capturing gestures is not limited in particular. For example, the user input unit 514 may include a camera that images the movement of the limbs of a Ghost, and an image recognition apparatus that processes the captured image. In addition, a marker may be attached to the body of a Ghost to facilitate image recognition. Alternatively, the user input unit 514 includes a gyro sensor or an acceleration sensor attached to the body of the Ghost, and detects the motion of the body of the Ghost.

The user input unit 514 may transmit an input gesture from the communication unit 511 to the image providing apparatus 101, for example, as control signals for intervening in the body of a Body. In addition, the user input unit 514 may convert the input gesture into image information (coordinate information, AR image to be superimposed and displayed, character information (text information), or the like) for intervening in the vision of the Body, or sound signals for intervening in the hearing of the Body, and transmit the image information or the sound signals from the communication unit 511 to the image providing apparatus 101. In addition, the user input unit 514 identifies, by performing image analysis or the like, position information in the three-dimensional space corresponding to a pixel position indicated by a gesture of a Ghost, and transmits the position information in the three-dimensional space to the image providing apparatus 101. Thus, the Ghost is able to perform pointing that achieves fixation not on the pixel coordinates, but in a space.

Additionally, the user input unit 514 inputs an action of a Ghost obtained on the basis of image analysis of the Ghost imaged by a camera, a detection result of a gyro sensor or an acceleration sensor attached to the body of the Ghost, or the like as an instruction to move in the virtual space (VR space) or the like.

A service that is referred to as JackIn and developed in the visual information sharing system 100 resembles the general AR technology from the perspective of superimposing and displaying an AR image. However, it is considered that JackIn is different from the normal AR technology performed by a computer in that a human (Ghost) augments another human (Body).

In addition, JackIn also resembles telepresence (described above) in some sense. However, normal telepresence and JackIn are different in that the normal telepresence is an interface for viewing the world from the viewpoint of a machine such as a robot, while, in JackIn, a human (Ghost) views the world from the viewpoint of another human (Body). In addition, telepresence presupposes that a human serves as a master and a machine serves as a slave, and the machine serving as a slave truly reproduces the motion of the human. In contrast, in the case where a human (Ghost) performs JackIn to another human (Body), the Body does not necessarily move in accordance with the Ghost, and is an independent interface.

In the above-described visual information sharing system 100, video provided from the image providing apparatus 101 to the image display apparatus 102 is not limited to real-time video observed by a Body on a site (i.e., live video captured by the imaging unit 501), but may be recorded past video. For example, the image providing apparatus 101 includes a mass storage apparatus (not illustrated) that records past video, and the past video may be distributed from the image providing apparatus 101. Alternatively, the past video recorded by the image providing apparatus 101 may be accumulated on a JackIn server (provisional name) that controls JackIn between a Body and a Ghost or another recording server, and the past video may be streamed from these servers to a Ghost (image display apparatus 102). However, in the case where the Ghost views the past video, intervention in the Body including visual intervention and auditory intervention may be regarded as being not permitted at all. This is because the video viewed by the Ghost is not the video of a site where the Body is currently performing operation, and intervention based on the past video hinders the current operation of the Body.

Note that, for the details of visual sharing between two apparatuses, for example, the specification of Patent Application No. 2013-78893, which has already been transferred to the present applicant, should also be seen. In addition, for the details of visual intervention (display of AR image) in the same system 100, for example, the specification of Patent Application No. 2013-78892, the specification of Patent Application No. 2013-78894, and the specification of Patent Application No. 2013-191464, which have already been transferred to the present applicant, should also be seen.

C. Mission-Permission (Matching between Body and Ghost)

JackIn offers a plurality of communication channels such as “visual intervention,” “auditory intervention,” “body intervention,” and “alternative conversation.” Therefore, by starting JackIn with a Ghost, a Body is able to share the vision of the Body with the Ghost, and be assisted, instructed, guided, and navigated by the Ghost regarding operation that is currently performed through visual intervention or the like. In addition, by starting JackIn with the Body, the Ghost is able to have the same experience as that of the Body without visiting a site, and assist, instruct, guide, and navigate the Body regarding operation thereof through visual intervention or the like.

However, when the Ghost unlimitedly intervenes in the Body's own vision, hearing, or body or carries out alternative conversation, the Body's behavior is sometimes interrupted by the Ghost, or the Body's behavior is sometimes hindered and subjected to danger, and the Body's privacy is invaded in some cases. Meanwhile, the Ghost also has some video that the Ghost does not want to watch in some cases, is not able to provide services such as appropriate assistance, instruction, guidance, and navigation even if asked by the Body. That is, a mismatch between the Body and the Ghost is problematic.

Accordingly, in the present embodiment, to achieve appropriate matching between a Body and a Ghost, “permission” and “mission” are defined. The range within which the Body permits intervention from the Ghost is defined as “permission,” and intervention from the Ghost is limited to the range prescribed by the permission. Meanwhile, the range of operation in which the Ghost intervenes in the Body is defined as “mission,” and the range within which the Ghost attempts to intervene in the Body is limited to the range prescribed by the mission. Note that a matching condition for a Body to provide information to a Ghost may be regarded as a first condition in the technology of the present disclosure. In addition, a matching condition to provide information output from a Ghost to a Body to the Body may be regarded as a second condition in the technology of the present disclosure.

### C-1. Permission

First, permission will be described. It is possible for respective Bodies to appropriately set permissions having different levels at which intervention is permitted as exemplified below.

(Level 1) Only exchange of vision is permitted. In this case, the image providing apparatus 101 only transmits a captured image of the imaging unit 501, but does not operate the output unit at all.
(Level 2) Only exchange of vision and up to visual intervention are permitted. In this case, the image providing apparatus 101 only transmits a captured image of the imaging unit 501, and makes a display output for the display unit 503.
(Level 3) Auditory intervention is further permitted. In this case, the image providing apparatus 101 transmits a captured image of the imaging unit 501, makes a display output for the display unit 503, and makes a sound output from the first sound output unit 504.
(Level 4) All kinds of intervention including body intervention and alternative conversation are permitted. In this case, the image providing apparatus 101 is capable of further driving the drive unit 505 and outputting sound to the outside from the second sound output unit 506.

In addition, each Body may provide not uniform permission to all the Ghosts, but individual permission to each Ghost.

For example, the Body may set permission according to a user attribute of the Ghost. It is assumed that the user attribute here includes not only personal information such as the age, the sex, the personal relationship with the Body (kinship, friendship, official position relationship, or the like), the place of birth, the occupation, and a qualification, but also rating information of the skill of assistance target operation and information such as the past performance of the Ghost (as an assistant, an instructor, or the like) including accumulated time of use (how many hours the Ghost has experienced the operation so far) or the like, and a review and a reputation (posting, voting result, or the like) of the Ghost from another Body. For example, in the case where the age of a Ghost does not satisfy a predetermined condition (first condition), content information to be provided to the Ghost may be restricted. Specifically, in the case where the age of a Ghost is out of a predetermined range set by a Body, content information to be provided to the Ghost may be restricted. Note that the information amount of content information may be smaller with decrease in the age of a Ghost. In the case where the sex of a Ghost is different from the sex of a Body, content information to be provided to the Ghost may be restricted. Alternatively, in the case where a Body is not able to acquire sex information of a Ghost, content information to be provided to the Ghost may be restricted. Alternatively, as the personal relationship (such as kinship, friendship, or official position relationship) between a Ghost and a Body is closer, the permission level may be higher. Alternatively, the permission level may be set in accordance with the degree of similarity between a Body and a Ghost in personal information. Such setting of the permission level based on the degree of similarity can be used to issue a request obtained by combining JackIn with an SNS or create a community.

The above-described setting (decision or restriction) of the information amount of content information is not limited to the editing of data (raw data) itself which is generated by an information processing apparatus of a Body, but various modes may be employed. For example, in the case where a display image is provided as content information, a mask image generated on the basis of raw data may be superimposed on the display image of the raw data to restrict content information. Alternatively, protection may be set for raw data. In addition, content information only has to be restricted by any of a Body (data providing unit), a server (data mediation unit), and a Ghost (data reception unit). In addition, a mask image serving as additional information only has to be generated by any of a Body, a server, and a Ghost. Meanwhile, to set different access control for content information according to each Ghost, it is desirable for a server to set the information amount of content information.

In addition, as partially described above, the Body does not set permission according to an attribute, but may individually set permission (permission for Mr./Ms. A, permission for Mr./Ms. B, . . . , and the like). In other words, permission may be set for each combination of a Body and a Ghost. The Body may set permission on the basis of the personal relationship with the Body, or set permission on the basis of the ability of the Ghost that the Body personally grasps. In addition, there is also a method of providing temporary permission to a Ghost by one-to-one negotiation, mediation, or the like between a Body and the Ghost (high-level permission is provided to a certain Ghost only for a predetermined period of time, and, when the period of time elapses, the permission is restored to the original-level permisson). In addition, the Body may set a user who is forbidden from performing JackIn to the Body.

Simple examples of the permission settings based on a personal relationship will be shown below.

(Example 1) Others are permitted only sharing of vision (level-1 permission).
(Example 2) Friends are permitted up to visual intervention and auditory intervention (level-2 or level-3 permission).
(Example 3) Close friends or authenticated or qualified people are specially permitted body intervention (level-4 permission). Alternatively, alternative conversation is temporarily permitted.

Other examples of the permission settings include the case where a Body charges for (i.e., monetizes) JackIn as a service. Any one of the above-described level-1 permission to level-4 permission is set for a Ghost in accordance with a charge for use paid by the Ghost, and the Ghost is able to perform JackIn with the Body.

(Example 4) A Ghost who pays five dollars is permitted only sharing of vision (level-1 permission).
(Example 5) A Ghost who pays ten dollars is permitted up to visual intervention and auditory intervention (level-2 or 3 permission).
(Example 6) A Ghost who pays a hundred dollars is permitted body intervention (level-4 permission). Alternatively, alternative conversation is temporarily permitted.

### C-2. Mission

Next, mission will be described. In the present embodiment, the range of operation in which a Ghost intervenes in a Body is defined as “mission,” and the range within which the Ghost is able to intervene in the Body is limited to the range prescribed by the mission. The mission of the Ghost is set, for example, within the range of a mission to be carried out by the Ghost or the ability thereof. The mission is not freely decided by each Ghost, but it is preferable that the mission be permitted or authenticated, for example, by an authoritative organization or the like. That is, as partially described above, it is possible to define missions having different levels as exemplified below in accordance with a mission or a duty to be carried out by a Ghost, the occupation, a qualification, the rating of an intervention skill, the past performance (experience time as a Ghost or the like) of the Ghost (as an assistant, an instructor, or the like), and a review and a reputation (posting, voting result, or the like) from a Body, or the like.

(Level 1) Only exchange of vision is performed. In this case, the image display apparatus 102 only displays an image received from the image providing apparatus 101.
(Level 2) Exchange of vision and up to visual intervention are performed. In this case, the image display apparatus 102 displays an image received from the image providing apparatus 101, and transmits information regarding an image (image to be superimposed and displayed and to intervene in the vision) to be displayed on the image providing apparatus 101 side.
(Level 3) Auditory intervention is further performed. In this case, the image display apparatus 102 further transmits information regarding sound (sound to which a Body should be caused to listen) to be output by the image providing apparatus 101.
(Level 4) All kinds of intervention including body intervention and alternative conversation are performed. In this case, the image display apparatus 102 further transmits information for operating the drive unit 505 and information regarding sound to be output from the second sound output unit 506 to the outside.

In the case where a Body starts JackIn with a Ghost, it is only necessary to perform filtering on the basis of personal information and attribute information of the Ghost and further compare permission designated by the Body with a mission that the Ghost has, thereby determining whether or not JackIn is possible and the range within which intervention is possible in a JackIn state. For example, filtering processing is effective when a Body takes the initiative in starting JackIn (Body initiative start) by targeting an unspecified large number of Ghosts (Large number Ghost).

Such filtering processing may be performed on the Body side (i.e., image providing apparatus 101) or by a JackIn server (provisional name) that controls JackIn between a large number of Bodies and a large number of Ghosts.

By setting permission for a Body and setting a mission for a Ghost, it is easy to automatize processing of selecting a Ghost at the time of starting JackIn and processing of deciding the range within which the Ghost performs intervention. For example, when an unspecified large number of Ghosts perform JackIn, the Body is able to mechanically determine the level at which each Ghost is permitted intervention, which is convenient. Needless to say, it is not mechanically determined on the basis of information such as permis son and mission set in advance, but may be determined on the spot whether or not it is possible to perform JackIn or an intervention level on the basis of one-to-one negotiation, mediation, or the like between a Body and a Ghost.

D. JackIn start flow

JackIn is the situation in which a Ghost is immersed and views video sent from a Body in the visual information sharing system 100, and the Ghost interacts with the Body.

As described above, JackIn is roughly classified into the case where a Body takes the initiative in starting JackIn (Body initiative start) and the case where a Ghost takes the initiative in starting JackIn (Ghost initiative start).

As the case where a Body takes the initiative in starting JackIn, the situation in which a Body requests assistance, instruction, guidance, or navigation regarding operation that is currently performed is assumed. For example, there are a common situation in which a Body requests a person to teach car repair work and a situation in which a Body requests assistance, instruction, guidance, or navigation regarding operation demanding relatively high-level technology or skill in a medical field including surgery and the like, and a construction site of a construction work and the like, and other sites.

JackIn is basically started when a Ghost enters (jacks in) a Body. Thus, in the case where a Body wants to take the initiative in starting JackIn, the Body requests a desired Ghost (or a predetermined number of Ghosts) to enter the Body, and then starts operation in a standby state.

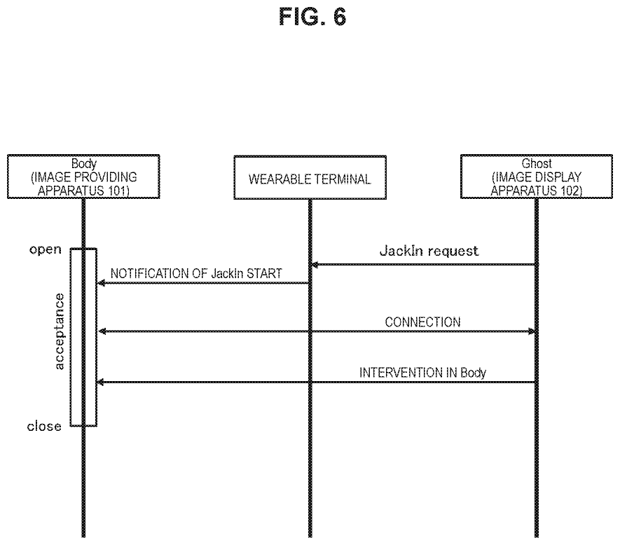

FIG. 6 schematically illustrates a start flow of Body initiative start. FIG. 6 illustrates only a single Ghost for the sake of simplification. However, a plurality of Ghosts are assumed to exist.

A Body starts operation, in the above-described standby state, while opening “acceptance” for accepting Ghosts.

Note that a Body side requests a Ghost to perform JackIn in any form. For example, a Body may invite Ghosts by posting comments such as “Need help!” “Please teach me how to drive a car”, and “Please tell me the way to 00” with a social networking service (SNS). In this way, the matching condition (first condition) for a Ghost to perform JackIn to a Body may be set in accordance with an input from the Body. In addition, a Ghost may charge for (monetize) a service to perform JackIn to assist, instruct, guide, or navigate a Body regarding the operation thereof. A Body may also present a payable price at the time of inviting Ghosts on an SNS or the like. A Ghost who answers the invitation transmits a JackIn request.

When an external apparatus (such as an information terminal apparatus or an information processing apparatus: a wearable terminal worn by the user of the image providing apparatus 101) receives the JackIn request from the Ghost (image display apparatus 102) instead of the Body (image providing apparatus 101), the external apparatus notifies the Body.

When the Body receives the notification from the wearable terminal while opening acceptance, the Body establishes connection with the Ghost.

When the Body performs JackIn with a desired Ghost or the number of connected Ghosts reaches a predetermined number, the Body closes acceptance to accept no notifications from wearable terminals. Afterward, the Body shares vision with the Ghost who has performed JackIn to the Body, and performs the operation while being subjected to visual intervention or other intervention from the Ghost.

Note that, when the Body is connected to the Ghost, it is mechanically determined on the basis of a selection criterion such as the past performance and review of the Ghost or is directly determined by the user whether or not connection can be established. In addition, in the case where a plurality of Ghosts have performed JackIn to the Body, it is also assumed that permission or mission to be set is different for each Ghost. In this case, a higher permission level may be set for a Ghost having a higher degree of matching between a Body and a Ghost that a user having a relatively lower degree of matching. That is, in the case where the number of Ghosts who are able to perform JackIn to Bodies is restricted, a Ghost having a relatively lower degree of matching can have a restricted information amount provided from a Body or can be permitted no JackIn in some cases even if the Body matches the Ghost. Alternatively, at least one intervention mode may be restricted uniformly for a plurality of Ghosts in accordance with the number of Ghosts reaching a predetermined number. For example, the degree of each type of intervention may be required in accordance with the number of Ghosts. This can suppress excessive intervention of a large number of Ghosts in a Body.

In addition, in the case where the Body takes the initiative in performing JackIn with a (unspecified) large number of Ghosts, JackIn is also basically started in accordance with a sequence similar to the sequence in FIG. 6. As the case where the Body takes the initiative in performing JackIn with a (unspecified) large number of Ghosts, a situation is assumed in which the Body requests advice or slight operation such as operation like an assistant from unspecified people.

The Body invites Ghosts who perform JackIn to the Body on an SNS or the like, and starts operation in a standby state. Whenever the wearable terminal receives a JackIn request from a Ghost, the wearable terminal notifies the Body. When the Body is connected to a Ghost, it is mechanically determined on the basis of a selection criterion such as the past performance and review of the Ghost or is directly determined by the user whether or not connection can be established. In addition, in the case where a plurality of Ghosts have performed JackIn to the Body, it is also assumed that permission or mission to be set is different for each Ghost.

Meanwhile, the procedure in which a single Ghost (or a specified small number of Ghosts) takes the initiative in starting JackIn is basically achieved by the Ghost entering (jacking in) the Body. This action resembles operation in which the Ghost makes a phone call to the Body.

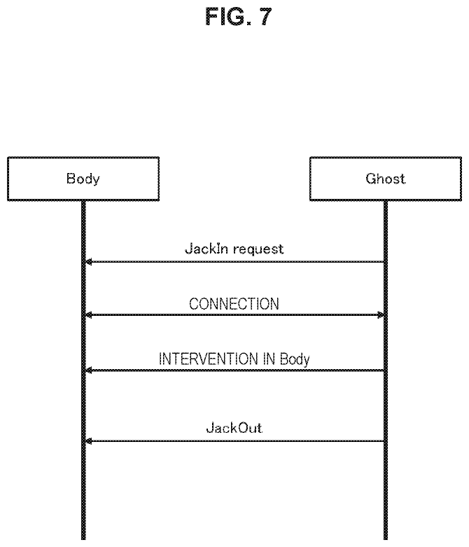

FIG. 7 schematically illustrates a start flow of Ghost initiative start. A JackIn request is transmitted from a Ghost to a Body, and a JackIn state is achieved. Video is transmitted from the Body to the Ghost, and the Ghost intervenes in the Body.

Note that, when the Body is connected to the Ghost, it is mechanically determined on the basis of a selection criterion such as the past performance and review of the Ghost or is directly determined by the user whether or not connection can be established. In addition, at that time, the Body may set permission for the Ghost who has performed JackIn to the Body, and the Ghost may set his or her own mission. The image providing apparatus 101 and the image display apparatus 102 may present a user interface (UI) for setting permission and a UI for setting a mission to the users, respectively.

In addition, in the case where a (unspecified) large number of Ghosts take the initiative in performing JackIn with the Body, the Body is able to set a start condition of JackIn in advance. In this case, the wearable terminal is set to not notify the Body whenever a JackIn request is received from a Ghost, but notify the Body only when the start condition is satisfied.

For example, it is possible to set the number of Ghosts who answer invitation as the start condition. In this case, when the number of Ghosts from whom JackIn requests have been received reaches a predetermined number or larger, the wearable terminal notifies the Body. Only when the number of Ghosts reaches one hundred or larger, video is distributed from the Body present on a site. A specific example includes a use case where video distribution is started when a Body who participates in a festival writes a message such as “I'm attending the festival now” and the number of Ghosts who want to view the festival reaches one hundred or larger.

The overview of a start flow of JackIn in each case is summarized in the following Table 1.

TABLE 1

| | Single (or small number) | |
|---|---|---|
| | Ghost | Large number Ghost |
| Body | A Body opens acceptance of | In a case where a Body |
| initiative | JackIn and starts operation. | requests advice from |
| start | When a Ghost receives a | unspecified Ghosts, the |
| | JackIn REQ and starts JackIn, | Body opens acceptance of |
| | the Body is notified, and | JackIn and starts operation. |
| | then sharing of vision and | When a Ghost enters the |
| | operation for intervention | Body, the Body is notified. |
| | are started. | |
| Ghost | A Ghost transmits a JackIn | A Body sets a start condition. |
| initiative | REQ to a specified Body, | When the start condition is |
| start | and, when the Body responds | satisfied, a JackIn REQ is |
| | thereto, JackIn is started. | transmitted to the Body. |

### E. Automatic Matching Processing of Mission-Permission

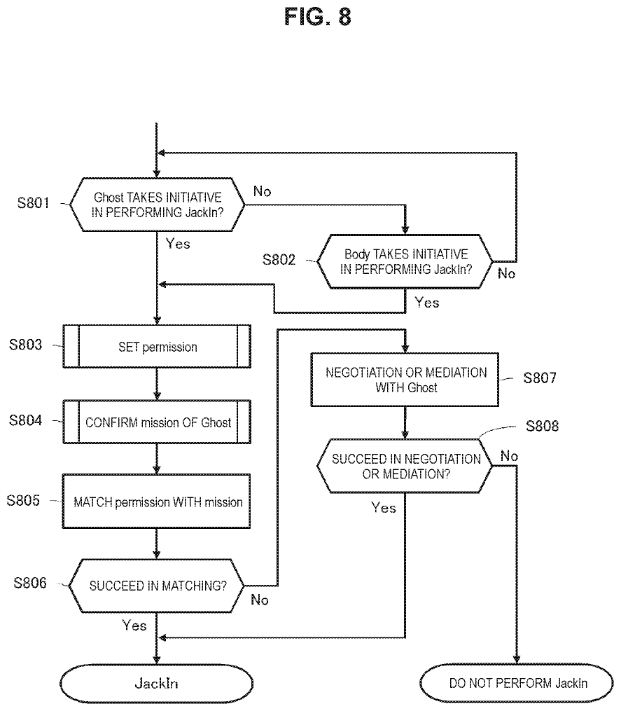

FIG. 8 illustrates a schematic processing procedure for matching permission set for a Body with a mission set for a Ghost in the form of a flowchart. FIG. 8 illustrates the processing procedure performed when a Ghost performs JackIn to a Body, but it is assumed that matching processing is also performed as needed in the case where a Body changes permission in the JackIn state, the case where a Ghost changes a mission in the JackIn state, or the like. It is assumed that the matching processing as illustrated in FIG. 8 is performed by not only the image providing apparatus 101, but also a server apparatus (not illustrated) interposed between the image providing apparatus 101 and the image display apparatus 102.

In the case where a Ghost takes the initiative in starting JackIn (Yes in step S801), or the case where a Body takes the initiative in starting JackIn (No in step S801 and Yes in S802), the Body sets the permission level for the Ghost who attempts to perform JackIn (step S803).

Next, the Body confirms the mission level set for the Ghost who attempts to perform JackIn (step S804).

The Body then matches the permission level set by the Body with the mission level of the Ghost (step S805).

Here, in the case where the permission level matches the mission level (Yes in step S806), the Body and the Ghost enter the JackIn state. The transmission of video from the Body to the Ghost is started, and it is possible to share vision between the Body and the Ghost and it is possible for the Ghost to intervene in the Body within the range within which the matching is established.

The case where the permission level matches the mission level means, for example, the case where it is possible to perform all the types of intervention at the mission level of the Ghost within the range of the intervention permitted at the permission level set by the Body.

Meanwhile, in the case where the permission level does not match the mission level (No in step S806), negotiation or mediation is attempted between the Body and the Ghost (step S807). For example, the Body requests the Ghost to lower the mission level to balance with the permission level. Alternatively, the Ghost requests the Body to raise the permission level to completely carry out a desired mission.

Then, in the case where negotiation or mediation is established (Yes in step S808), the Body and the Ghost enter the JackIn state. The sharing of vision is started between the Body and the Ghost, and intervention of the Ghost in the Body is started within the range within which the matching is established.

In addition, in the case where no negotiation or no mediation is established (No in step S808), JackIn between the Body and the Ghost is cancelled. As a result, no video is shared between the Body and the Ghost. In addition, the Ghost is not able to intervene in the Body at all.

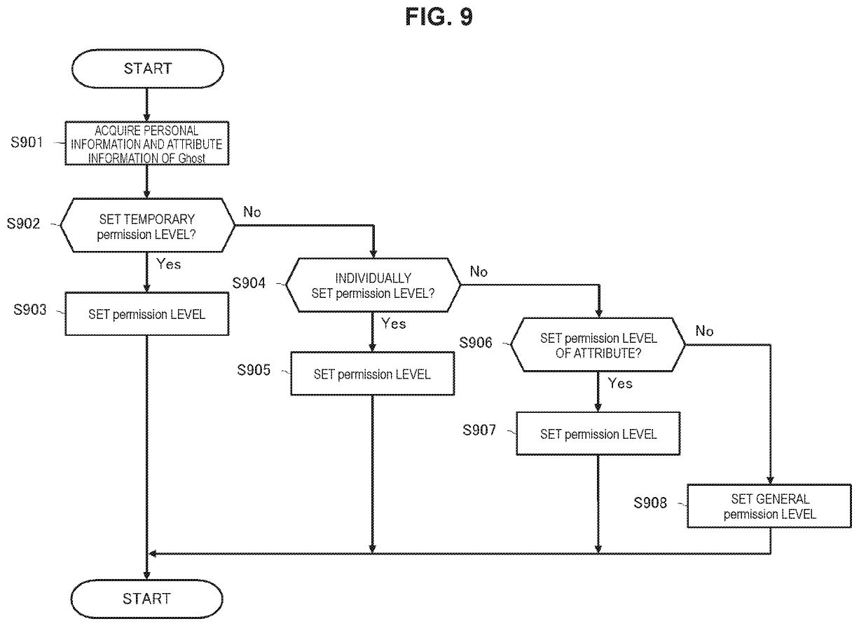

FIG. 9 illustrates the processing procedure for a Body to set the permission level for a Ghost, which is executed in step S803 in the flowchart illustrated in FIG. 8, in the form of a flowchart.

Personal information and attribute information of a Ghost to which a Body attempts to perform JackIn are acquired (step S901).

It is then checked whether or not the Body has set a limited-time temporary permission level (step S902). Then, in the case where a temporary permission level has been set (step Yes in S902), this is set as the permission level of the Ghost (step S903).

Next, it is checked whether or not the Body has personally set the permission level for the Ghost (step S904). Then, in the case where the permission level has been personally set for the Ghost (step Yes in S904), this is set as the permission level of the Ghost (step S905).

Next, it is checked whether or not the Body has set the permission level for the Ghost with respect to the attribute (step S906). Then, in the case where the permission level has been set for the attribute of the Ghost (step Yes in S906), this is set as the permission level of the Ghost (step S907).

It is assumed that the attribute here includes not only personal information such as the age, the sex, the personal relationship with the Body (kinship, friendship, boss and subordinate, or the like), the place of birth, the occupation, and a qualification, but also rating information of the skill of assistance target operation and information such as the past performance of the Ghost (as an assistant, instructor, or the like) (how many hours the Ghost has experienced the operation so far), a review of the Ghost, and a reputation (posting, voting result, or the like) of the Ghost from another Body (described above).

In addition, in the case where the Body has not set the permission level for an individual Ghost or each user attribute (No in step S906), the general permission level provided from the Body to all the Ghosts is set as the permission level of the Ghost (step S908). The general permission level is, for example, a level at which only vision is shared or only visual intervention is permitted.

F. Matching Processing of Mission-Permission with UI Operation

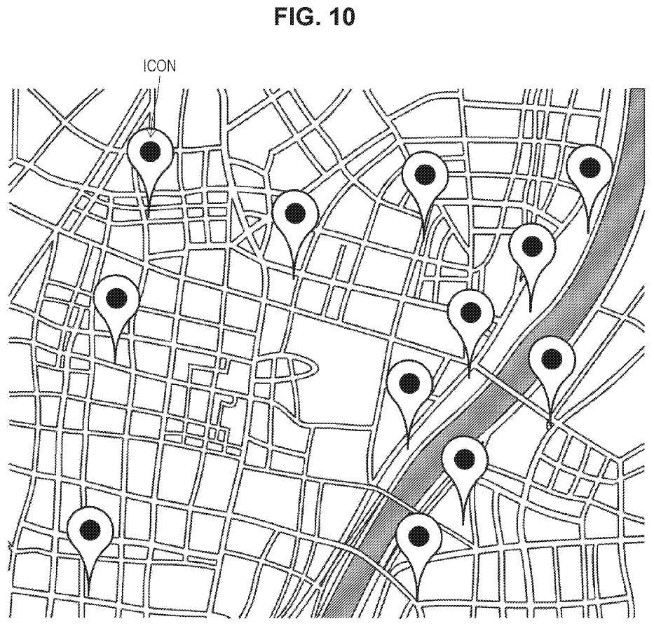

FIG. 10 illustrates an example of a UI that allows a Ghost to select a Body on the basis of position information of Bodies. In FIG. 10, an icon (or character) indicating the current position of each Body is displayed on a map of the range that is currently designated. Such a UI is displayed on, for example, the display unit 514 of the image display apparatus 102, and the user, that is, the Ghost is able to select a Body to whom the Ghost wants to perform JackIn by designating the icon at a desired position according to UI operation such as a touch or a click. It is possible to cause an area displayed as a map to transition by operation such as dragging or moving a cursor.

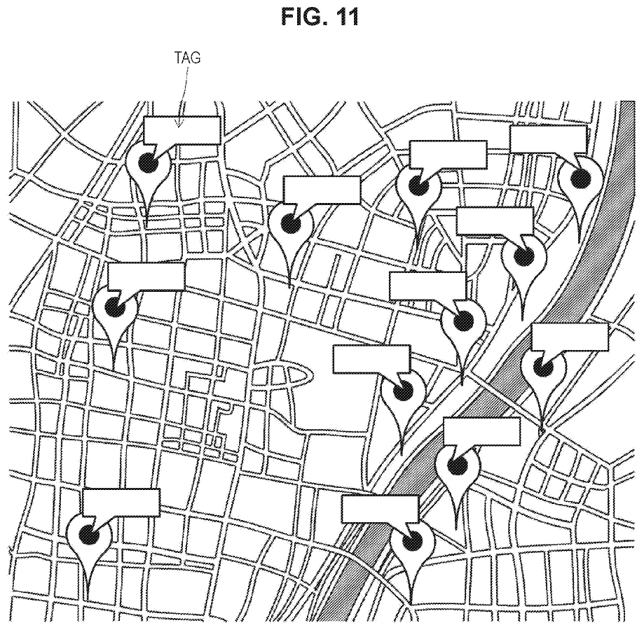

FIG. 11 illustrates another example of a UI that allows a Ghost to select a Body on the basis of position information of Bodies. FIG. 11 is a modification of the UI illustrated in FIG. 10, and a tag indicating additional information or the like regarding each Body is added to the icon of the Body. However, when tags are constantly displayed on all the icons in the UI display example illustrated in FIG. 11, display becomes complicated and it is difficult to read the map. Accordingly, the number of tags that are simultaneously displayed may be restricted by displaying only a tag of an icon that is provisionally selected by a touch, a click, hovering, or the like, or the like. The Ghost is able to select a Body for which a desired permission level is set through the UI illustrated in FIG. 11, and perform JackIn.

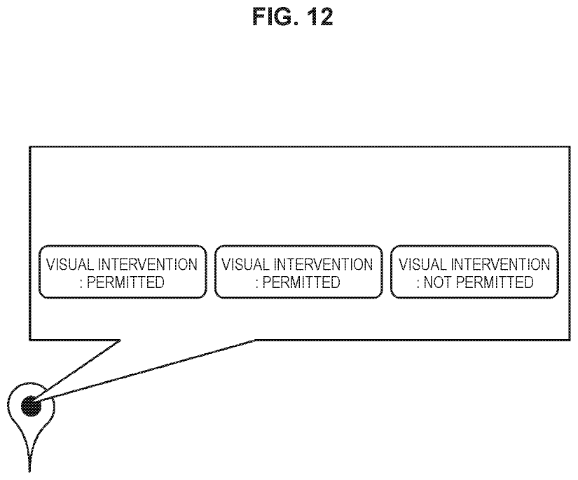

FIG. 12 illustrates a display example of a tag added to the icon of a Body. The illustrated example shows whether or not the Body permits each intervention operation such as visual intervention, auditory intervention, body intervention, and alternative conversation. By referring to such a tag, the Ghost is able to easily determine the permission level of each Body, that is, what the Ghost is able to do at that location when the Ghost performs JackIn to the Body.

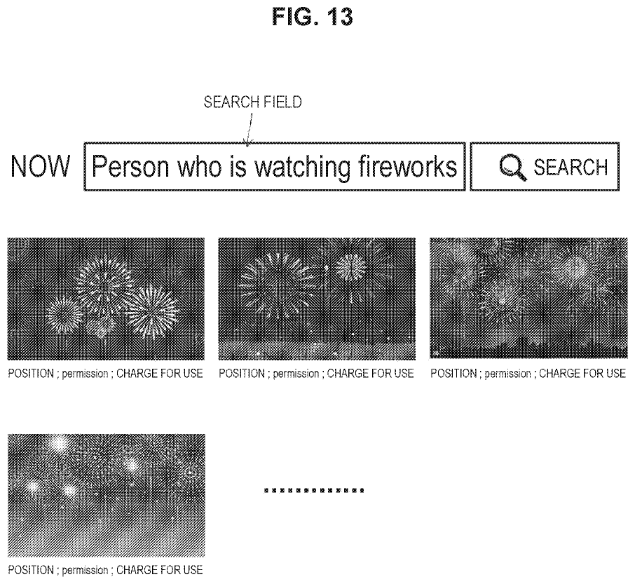

FIG. 13 illustrates another example of a UI that allows a Ghost to select a Body. FIG. 13 illustrates thumbnails of video transmitted from respective Bodies in the form of lists. The thumbnail of each video may be displayed together with tag information such as the behavior of the Body, the current position of the Body, the acceptance state, the permission settings, and the charge information. The Ghost is able to select a Body for which a desired permission level is set through the UI illustrated in FIG. 12, and perform JackIn.

In addition, FIG. 13 is a display example in which Bodies serving as JackIn targets are limited to “people who are watching fireworks.” For example, the JackIn server (provisional name) that controls JackIn between Bodies and Ghosts searches for a Body matching with a keyword (here, behavior of a Body) input to a search field. A search for Bodies is conducted without associating the Bodies with any place, which is different from the example illustrated in FIG. 10 or 11. Accordingly, Bodies present in separate places such as Hokkaido and Okinawa are sometimes displayed simultaneously as search results as long as the Bodies are “watching fireworks.”

In the above-described embodiments, the selection of the types of outputs or inputs regarding the setting of permission levels has been chiefly described. However, the setting of the information amount of content information is not limited thereto. As described above, the information amount of content information may be restricted by setting the degree of each type of intervention. For example, in the case where content information to be provided includes image information, the angle of view or the area of the image information may be restricted. This restricts the provision of part of the image information to a Ghost. This part of image information can include, for example, personal information of a Body or relevant information thereof. For example, in the case where raw data of content information is a full-dome image, a part of the body of a Body can be included in a provided image. Thus, the provision of an image of the body of a user to a Ghost side may be restricted by setting a permission level. Such restriction of the provision of an image of the body may be set in accordance with the sex of a Body and/or a Ghost. In addition, the quality of image information itself may also be restricted. The quality of image information can be restricted by controlling a parameter such as the resolution, the frame rate, the transmission rate, or the decoding rate. In the case where the information processing apparatus on the Body side is capable of acquiring and providing biological information of the user, the provision of the biological information to the Ghost side may be restricted. In addition, in the case where the age of the Ghost is less than or equal to a predetermined age, the provision of stereoscopic content requiring stereopsis may be restricted. In the case where the provision of stereoscopic content is restricted, image information may be processed to convert the content into 2D content. Alternatively, the provision of stereoscopic content may be forbidden. This makes it possible to restrict influence on young age groups brought about by viewing stereoscopic content. In addition, content information to be provided to a Ghost may be restricted in accordance with the performance or output format of an information processing apparatus of the Ghost. For example, before content information is provided to a Ghost, the content information may be converted or changed into a non-360-degree image. This makes it possible to suppress excessive increase in the amount of data to be provided to the Ghost. In addition, in the case where attribute information of a Ghost includes information indicating that physical ability such as visual ability or auditory ability is restricted, a permission level may be set such that an output format desirable for the Ghost is prioritized. For example, in the case where the visual ability is restricted, it is desirable to preferentially restrict the provision of sound information and/or tactile information.

### INDUSTRIAL APPLICABILITY

The above describes the technology disclosed in this specification in detail with reference to specific embodiments. However, it is obvious that persons skilled in the art may make modifications and substitutions to these embodiments without departing from the spirit of the technology disclosed in this specification.

The technology disclosed in the present specification is usable for, for example, operation support and the like in various industrial fields such as a medical field including surgery and the like, a construction site of a construction work and the like, the control of airplanes and helicopters, the navigation of a driver of an automobile, an instruction in sports, and the like.

In addition, in the present specification, an embodiment of a system in which a Ghost who shares an image with a Body who acts on a site with his/her body intervenes in the vision, the hearing, or the like of the Body has been mainly described. However, the gist of the technology disclosed in the present specification is not limited thereto. It is also possible to apply the technology disclosed in the present specification to various information processing apparatuses that display, on the vision of a certain person, information regarding assistance, instruction, guidance, and navigation from another person.

In short, the technology disclosed in the present specification has been described by way of example, and the stated content of the present specification should not be interpreted as being limiting. The gist of the technology disclosed in the present specification should be determined in consideration of the claims.

Additionally, the technology disclosed in the present specification can also be configured as below.

(1)

An information terminal apparatus connectable to an imaging unit and a sound input unit, the information terminal apparatus including:

a control unit;

a communication unit;

an access reception unit configured to receive access from an external information processing apparatus; and

a setting unit configured to, on a basis of information regarding an attribute of the information processing apparatus from which the access reception unit receives access, or a user of the information processing apparatus, set a range of information to be provided to the information processing apparatus, in which

the control unit transmits image information input from the imaging unit to the information processing apparatus via the communication unit within the range of information set by the setting unit.

(2)

The information terminal apparatus according to (1), further including:

an information reception unit configured to receive at least one of a plurality of pieces of information from the information processing apparatus, the plurality of pieces of information including sound information, text information, or image information.

(3)

The information terminal apparatus according to (1), in which

the setting unit sets a range of information to be provided to the information processing apparatus on a basis of information regarding an attribute of a user of the information processing apparatus, the information including information of at least one of age, sex, a personal relationship (kinship, a friendship, an official position relationship, or the like) with the user of the information terminal apparatus, a place of birth, an occupation, a qualification, a review made by the user of the information terminal apparatus, or accumulated time of use.

(4)

The information terminal apparatus according to (1), in which

the setting unit is capable of setting only image information input from the imaging unit, or only sound information input from the sound input unit as the range of information to be provided to the information processing apparatus.

(5)

The information terminal apparatus according to (2), further including:

an information output unit configured to output information received from the information processing apparatus, in which

the setting unit further sets, on the basis of the information regarding the attribute of the information processing apparatus from which the access reception unit receives access, or the user of the information processing apparatus, a range of information to be received from the information processing apparatus, and

the control unit controls an output from the information output unit within the range of information set by the setting unit.

(6)

A control method for an information terminal apparatus connectable to an imaging unit and a sound input unit, the control method including:

an access reception step of receiving access from an external information processing apparatus;

a setting step of setting, on a basis of information regarding an attribute of the information processing apparatus from which the access reception unit receives access, or a user of the information processing apparatus, a range of information to be provided to the information processing apparatus; and

a control step of controlling transmission of image information input from the imaging unit to the information processing apparatus within the range of information set in the setting step.

(7)

An information processing apparatus that accesses an information terminal apparatus capable of connecting an imaging unit and a sound input unit, the information processing apparatus including:

a control unit;

a communication unit; and

an access transmission unit configured to transmit access to the information terminal apparatus, in which

the control unit receives image information input from the imaging unit from the information terminal apparatus via the communication unit within a range of information set on a basis of information regarding an attribute of the information processing apparatus or a user of the information processing apparatus.

(8)

A control method for an information processing apparatus that accesses an information terminal apparatus capable of connecting an imaging unit and a sound input unit, the control method including:

an access transmission step of transmitting access to the information terminal apparatus; and

an information reception step of receiving image information input from the imaging unit from the information terminal apparatus via the communication unit within a range of information set on a basis of information regarding an attribute of the information processing apparatus or a user of the information processing apparatus.

(9)

A server apparatus interposed between an information terminal apparatus that is connectable to an imaging unit and a sound input unit, and an information processing apparatus that accesses the information terminal apparatus, the server apparatus including:

an access reception unit configured to receive access from the information processing apparatus to the information terminal apparatus;

a setting unit configured to, on a basis of information regarding an attribute of the information processing apparatus from which the access reception unit receives access, or a user of the information processing apparatus, set a range of information to be provided to the information processing apparatus; and

a control unit configured to control transmission of image information to the information processing apparatus within the range of information set by the setting unit, the image information being input to the information terminal apparatus from the imaging unit.

(10)

A control method for a server apparatus interposed between an information terminal apparatus that is connectable to an imaging unit and a sound input unit, and an information processing apparatus that accesses the information terminal apparatus, the control method including:

an access reception step of receiving access from the information processing apparatus to the information terminal apparatus;

a setting step of setting, on a basis of information regarding an attribute of the information processing apparatus from which access is received in the access reception step, or a user of the information processing apparatus, a range of information to be provided to the information processing apparatus; and

a control step of controlling transmission of image information to the information processing apparatus within the range of information set in the setting step, the image information being input to the information terminal apparatus from the imaging unit.

(11)

An information processing apparatus including:

a setting unit configured to, in response to a request of access of an information terminal apparatus of a second user to content information associated with a space of a first user, set an information amount of the content information to be provided to the second user on a basis of relevant information of at least one of the information terminal apparatus of the second user and the second user, or the content information.

(12)

The information processing apparatus according to (11), in which the relevant information of the second user includes attribute information of the second user.

(13)

The information processing apparatus according to (12), in which the attribute information of the second user includes information of at least one of age, sex, a personal relationship between the first user and the second user, a place of birth, an occupation, a qualification, a review made by the first user, or accumulated time of use.

(14)

The information processing apparatus according to (13), in which the personal relationship includes at least one of kinship, a friendship, or an official position relationship between the first user and the second user.

(15)

The information processing apparatus according to (13) or (14), in which in a case where the personal relationship shows a relatively low correlation, the setting unit sets a smaller information amount than in a case where the personal relationship shows a relatively high correlation.

(16)

The information processing apparatus according to any one of (13) to (15), in which in a case of a relatively early age, the setting unit sets a smaller information amount than in a case of a relatively advanced age.

(17)

The information processing apparatus according to any one of (12) to (16), in which in a case where the attribute information of the second user does not satisfy a first condition, the setting unit sets the information amount in accordance with the attribute information of the second user.

(18)

The information processing apparatus according to (17), in which the first condition is set in accordance with an input of the first user.

(19)

The information processing apparatus according to (17) or (18), in which the first condition is a condition that a degree of similarity between the attribute information of the second user and attribute information of the first user be greater than or equal to a predetermined value, or exceed the predetermined value.

(20)

The information processing apparatus according to any one of (11) to (19), further including:

an information reception unit configured to receive at least one of sound information, text information, or image information from the information terminal apparatus.

(21)

The information processing apparatus according to (20), in which the relevant information of the second user includes attribute information of the second user, and

in a case where the attribute information of the second user satisfies a second condition, at least one of the sound information, the text information, or the image information is provided to the first user.

(22)

The information processing apparatus according to (21), in which an information amount of at least one of the sound information, the text information, or the image information to be provided to the first user is set to be smaller in accordance with the attribute information of the second user than information amounts of the sound information, the text information, and the image information that are received.

(23)

The information processing apparatus according to any one of (11) to (22), further including:

an access reception unit configured to receive the request of access from the information terminal apparatus of the second user.

(24)

The information processing apparatus according to any one of (11) to (23), further including:

an information output unit configured to output input information of the second user received from the information terminal apparatus of the second user to the first user, in which the setting unit controls an output of the received input information from the information output unit on the basis of the relevant information.

(25)

The information processing apparatus according to any one of (11) to (24), in which the relevant information includes at least one of performance or an output format of the information terminal apparatus, and

the setting unit sets the information amount on a basis of the content information, and performance or an output format of the information terminal.

(26)

The information processing apparatus according to any one of (11) to (25), in which the setting unit sets only a captured image or only sound information acquired in a real space in which the first user exists or a virtual space as content information to be provided to the second user.

(27)

The information processing apparatus according to any one of (11) to (26), further including:

a control unit configured to control at least one of an imaging unit or a sound input unit that is connectable to the information processing apparatus;

a communication unit configured to communicate with the information terminal apparatus serving as an external apparatus;

an access reception unit configured to directly or indirectly receive a request of access from the information terminal apparatus; and

a housing configured to allow the first user to carry the setting unit, the communication unit, and the access reception unit.

(28)

The information processing apparatus according to any one of (11) to (26), in which

the information processing apparatus is a server apparatus on a network, the server apparatus directly or indirectly connecting communication between an information terminal apparatus of the first user and the information terminal apparatus of the second user.

(29)

An information processing method including:

a step of acquiring a request of access of an information terminal apparatus of a second user to content information associated with a space of a first user; and

a setting step of setting, in response to the acquired request of access, an information amount of the content information to be provided to the second user on a basis of relevant information regarding at least one of the information terminal apparatus of the second user and the second user, or the content information.

(30)

A computer program described in a computer-readable format, the computer program causing a computer to execute:

a step of acquiring a request of access of an information terminal apparatus of a second user to content information associated with a space of a first user; and

a setting step of setting, in response to the acquired request of access, an information amount of the content information to be provided to the second user on a basis of relevant information regarding at least one of the information terminal apparatus of the second user and the second user, or the content information.

### REFERENCE SIGNS LIST

100 visual information sharing system
101 image providing apparatus
102 image display apparatus
501 imaging unit
502 image processing unit
503 display unit
504 first sound output unit
505 drive unit
506 second sound output unit
507 position detection unit
508 communication unit
509 control unit
510 setting unit
511 communication unit
512 image decoding unit
513 display unit
514 user input unit
515 position attitude detection unit
521 sound input unit
522 sound processing unit

1. An information processing apparatus comprising:
a setting unit configured to, in response to a request of access of an information terminal apparatus of a second user to content information associated with a space of a first user, set an information amount of the content information to be provided to the second user on a basis of relevant information of at least one of the information terminal apparatus of the second user and the second user, or the content information.

2. The information processing apparatus according to claim 1, wherein
the relevant information of the second user includes attribute information of the second user.

3. The information processing apparatus according to claim 2, wherein
the attribute information of the second user includes information of at least one of age, sex, a personal relationship between the first user and the second user, a place of birth, an occupation, a qualification, a review made by the first user, or accumulated time of use.

4. The information processing apparatus according to claim 3, wherein
the personal relationship includes at least one of kinship, a friendship, or an official position relationship between the first user and the second user.

5. The information processing apparatus according to claim 3, wherein
in a case where the personal relationship shows a relatively low correlation, the setting unit sets a smaller information amount than in a case where the personal relationship shows a relatively high correlation.

6. The information processing apparatus according to claim 3, wherein
in a case of a relatively early age, the setting unit sets a smaller information amount than in a case of a relatively advanced age.

7. The information processing apparatus according to claim 2, wherein
in a case where the attribute information of the second user does not satisfy a first condition, the setting unit sets the information amount in accordance with the attribute information of the second user.

8. The information processing apparatus according to claim 7, wherein
the first condition is set in accordance with an input of the first user.

9. The information processing apparatus according to claim 7, wherein
the first condition is a condition that a degree of similarity between the attribute information of the second user and attribute information of the first user be greater than or equal to a predetermined value, or exceed the predetermined value.

10. The information processing apparatus according to claim 1, further comprising:
an information reception unit configured to receive at least one of sound information, text information, or image information from the information terminal apparatus.

11. The information processing apparatus according to claim 10, wherein
the relevant information of the second user includes attribute information of the second user, and
in a case where the attribute information of the second user satisfies a second condition, at least one of the sound information, the text information, or the image information is provided to the first user.

12. The information processing apparatus according to claim 11, wherein
an information amount of at least one of the sound information, the text information, or the image information to be provided to the first user is set to be smaller in accordance with the attribute information of the second user than information amounts of the sound information, the text information, and the image information that are received.

13. The information processing apparatus according to claim 1, further comprising:
an access reception unit configured to receive the request of access from the information terminal apparatus of the second user.

14. The information processing apparatus according to claim 1, further comprising:
an information output unit configured to output input information of the second user received from the information terminal apparatus of the second user to the first user, wherein
the setting unit controls an output of the received input information from the information output unit on the basis of the relevant information.

15. The information processing apparatus according to claim 1, wherein
the relevant information includes at least one of performance or an output format of the information terminal apparatus, and
the setting unit sets the information amount on a basis of the content information, and performance or an output format of the information terminal.

16. The information processing apparatus according to claim 1, wherein
the setting unit sets only a captured image or only sound information acquired in a real space in which the first user exists or a virtual space as content information to be provided to the second user.

17. The information processing apparatus according to claim 1, further comprising:
a control unit configured to control at least one of an imaging unit or a sound input unit that is connectable to the information processing apparatus;
a communication unit configured to communicate with the information terminal apparatus serving as an external apparatus;
an access reception unit configured to directly or indirectly receive a request of access from the information terminal apparatus; and
a housing configured to allow the first user to carry the setting unit, the communication unit, and the access reception unit.

18. The information processing apparatus according to claim 1, wherein
the information processing apparatus is a server apparatus on a network, the server apparatus directly or indirectly connecting communication between an information terminal apparatus of the first user and the information terminal apparatus of the second user.

19. An information processing method comprising:
a step of acquiring a request of access of an information terminal apparatus of a second user to content information associated with a space of a first user; and
a setting step of setting, in response to the acquired request of access, an information amount of the content information to be provided to the second user on a basis of relevant information regarding at least one of the information terminal apparatus of the second user and the second user, or the content information.

20. A computer program described in a computer-readable format, the computer program causing a computer to execute:
a step of acquiring a request of access of an information terminal apparatus of a second user to content information associated with a space of a first user; and
a setting step of setting, in response to the acquired request of access, an information amount of the content information to be provided to the second user on a basis of relevant information regarding at least one of the information terminal apparatus of the second user and the second user, or the content information.
